(19) United States
(12) Patent Application Publication
(10) Pub. No.: US 2026/0091558 A1
(43) Pub. Date: Apr. 2, 2026

(54) Direct Ink Writing Process Analytical Engine

(71) Applicant: Florida A&M University, Tallahassee, FL (US)

(72) Inventors: Tarik J. Dickens, Tallahassee, FL (US); Sean Psulkowski, Tallahassee, FL (US); Abdullah Al Noman, Tallahassee, FL (US); Solomon Andrews, Tallahassee, FL (US); Samantha Ysabel Rivera, Tallahassee, FL (US)

(21) Appl. No.: 19/344,686

(22) Filed: Sep. 30, 2025

Related U.S. Application Data
(60) Provisional application No. 63/701,130, filed on Sep. 30, 2024.

(51) Int. Cl. B29C 64/393; B29C 64/209; B33Y 30/00; B33Y 50/02

(52) U.S. Cl. CPC B29C 64/393; B29C 64/209; B33Y 30/00; B33Y 50/02

(57) ABSTRACT

A system and method are disclosed for auto-calibration of direct-ink writing (DIW) material flow. The system includes an imaging system comprising at least one camera and at least one illumination source, a rapid sample exchange system with a syringe compartment in fluidic communication with a nozzle of a printing apparatus, and a data analysis and inference engine communicatively coupled to the imaging system and the rapid sample exchange system. The imaging system captures thermal and optical images of extruded ink polymers in real time, and the inference engine processes the images to determine material flow characteristics including flow rate, deposition pattern, and adhesion. A control processor automatically adjusts extrusion parameters based on the processed data. The method includes capturing images of extruded polymers, comparing real-time data to historical datasets, adjusting extrusion parameters, and retraining a machine learning model to improve calibration of subsequent ink polymers.

### CROSS-REFERENCE TO RELATED APPLICATIONS

This nonprovisional application claims the benefit of U.S. Provisional Application No. 63/701,130 entitled “DIW PROCESS ANALYTICAL ENGINE” filed Sep. 30, 2024, by the same inventors, all of which is incorporated herein by reference, in its entirety, for all purposes.

### BACKGROUND OF THE INVENTION

### 1. Field of the Invention

This invention relates, generally, to additive manufacturing systems and processes. More specifically, it relates to direct ink writing (“DIW”) apparatuses and methods configured to control and calibrate material flow parameters of ink polymer electrolyte inks and other viscoelectric materials utilized in the fabrication of energy-based devices.

### 2. Brief Description of the Prior Art

Direct ink writing (“DIW”) is a form of additive manufacturing that relies on extrusion-based deposition of material through a nozzle onto an ink polymer. Unlike traditional fused filament fabrication, which is limited to thermoplastic filaments, DIW accommodates a broad range of inks including but not limited to gels, slurries, pastes, and/or ink polymer electrolytes. Due to this versatility, DIW has been increasingly applied in the fabrication of functional structures such as energy storage devices, solar cells, and/or biomedical apparatuses and structures. The ability to pattern materials with different rheological characteristics makes DIW a valuable tool for research and device prototyping.

The capabilities and effectiveness of the DIW process is governed by the rheological and morphological properties of the extruded ink. In this manner, inks used in DIW often exhibit shear thinning meaning the viscosity of the ink decreases as shear rate increases thereby allowing for controlled flow through a nozzle followed by structural recovery after deposition. Materials such as poly(ethylene oxide) (“PEO”) are particularly attractive for DIW because their viscoelastic behavior can be tuned by varying ink polymer concentrations, chain length, solvent composition, and/or a combination thereof.

Applications of DIW in the field of energy devices has been primarily focused on electrolyte inks for dye-sensitized solar cells (“DSSCs”) and related technologies. The electrolyte layer in such devices is essential for maintaining redox balance and charge transfer efficiency. PEO-based inks and similar quasi-solid electrolytes offer advantages in physical and chemical stability compared to liquid electrolytes. However, the printability of these inks is dependent on optimizing extrusion parameters to balance wettability, ion transport, and/or structural integrity.

Commonly known methods in the art regarding DIW printing involve manual adjustment of printing parameters such as nozzle size/dimensions, extrusion pressure, and/or stage velocity. As such, users must often conduct repeated trial-and-error experiments to determine a combination of parameters that yield a stable extrudate and acceptable printed structure. This process is not only time-consuming but also can be inconsistent as minor changes in ink formulation or ambient conditions can disrupt optimized settings. As a result, scaling DIW from laboratory demonstrations to reliable production remains a challenge.

Research studies have sought to better understand the correlation between ink rheology and printability. For example, by conducting rheometric tests such as shear stress sweeps and oscillatory strain sweeps, investigators have quantified the yield stress, storage modulus, and loss modulus of ink polymer electrolyte inks. These measurements have revealed that increasing ink polymer concentration results in higher viscosities and moduli, leading to greater stability after deposition but requiring higher pressures to initiate flow. Such findings provide valuable insight into ink behavior but have primarily been obtained in controlled laboratory experiments rather than integrated into printing systems.

Additionally, optical imaging techniques have been used to study flow characteristics during DIW. High-speed cameras and/or microscopes can be utilized to capture extrudate behavior such as die swell, spreading, arcing, and/or undulation. These parameters can result in dimensional inaccuracies if not properly monitored and/or maintained at a consistent rate leading to loss of structural fidelity and/or defects in the final printed part.

Moreover ultraviolet (“UV”) curing of photocurable inks can be used to adjust the microstructure of extrudates after deposition. By tuning parameters such as UV exposure time and nozzle velocity, researchers have been able to influence the aspect ratio and/or mechanical properties of the printed filaments.

Design-of-experiments approaches have also been applied to DIW such that parameter variations are systematically tested to evaluate their impact on extrudate shape and quality. These methods have provided quantitative relationships between nozzle height, extrusion speed, and resulting filament geometry. While valuable for mapping parameter spaces, such experimental frameworks are labor-intensive and require repeated manual interventions.

DIW methods and printing inks with complex rheological properties may exhibit unpredictable behavior, causing failed prints, wasted material, and/or extended downtime. This lack of automated calibration capability limits the adoption of DIW for industrial-scale manufacturing where reproducibility and efficiency at a large-scale level is necessary. Without systems capable of monitoring extrusion in real time and automatically tuning parameters in real-time DIW cannot reliably transition beyond research settings.

Accordingly, what is needed is a system and method for automated calibration and parameter tuning in direct ink writing systems, capable of analyzing extrusion behavior in real time and/or adjusting operating conditions to optimize printability across a wide range of inks and applications. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a system and method for auto-calibration of direct-ink writing (“DIW”) material flow. In an embodiment, the system for auto-calibration of DIW material flow comprises: (a) an imaging system including at least one camera and at least one illumination source; (b) a rapid sample exchange system including a syringe compartment in fluidic communication with a nozzle of a printing apparatus, wherein the syringe compartment is configured to transition between one or more ink polymers within the printing mechanism during operation; and (c) a data analysis and inference engine communicatively coupled to the imaging system and the rapid sample exchange system.

In some embodiments, the imaging system is configured to capture one or more thermal images, optical images, or both of the extruded ink polymer in real-time. Accordingly, in some embodiments, the data analysis and inference engine may be configured to process the captured images to determine material flow characteristics including flow rate, ink polymer deposition pattern, and ink polymer adhesion.

Additionally, in some embodiments, the data analysis and inference engine is further configured to automatically adjust extrusion parameters of the ink polymer from the printing mechanism, in real-time, based on the calculated flow rate, deposition pattern, and adhesion properties.

Moreover, in some embodiments, the imaging system comprises a plurality of cameras positioned about the printing mechanism at various elevations relative to the nozzle of the printing mechanism. In some embodiments, the imaging system further comprises an adaptive illumination source configured to optimize image quality for different ink polymers having various transparency, color, or both.

Additionally, in some embodiments, the rapid sample exchange system further comprises a temperature-controlled compartment configured to maintain a predetermined viscosity of the ink polymer during operation. In some embodiments, the system further comprises a control processor operably coupled to the printing mechanism, imaging system, rapid sample exchange system, and the data analysis and inference engine.

Furthermore, in some embodiments, the data analysis and inference engine may further comprise a data storage module configured to store calibration profiles, historical extrusion data of the ink polymers, or both. In some embodiments, the control processor is configured to implement predictive adjustments to extrusion pressure, nozzle temperature, or print speed.

In some embodiments, the data analysis and inference engine is configured to identify adhesion failure events from captured images and electrically communicate the failure events to the control processor, such that the processor adjusts the extrusion parameters in response.

In another aspect, the present disclosure pertains to a method of training an auto-calibration system for DIW material flow. In an embodiment, the method comprises: (a) providing the auto-calibration system; (b) capturing, in real-time via the imaging system, thermal or optical images of an extrudate ink polymer; (c) processing, in real-time via the data analysis and inference engine, the captured images to calculate extrusion parameters including flow rate, deposition patterns, and adhesion; (d) comparing the real-time captured data to a stored historical dataset of the extruded polymer; (e) adjusting, in real-time via a control processor, at least one extrusion parameter; and (f) retraining a machine learning model using the real-time calculated extrusion parameters and captured images along with the stored historical dataset for future calibration of printing one or more ink polymers.

In some embodiments, the method further comprises generating datasets from the captured images and extrusion parameters for training a machine learning algorithm to predict extrusion behavior of subsequent ink polymers. In some embodiments, the method includes identifying deviations in flow uniformity, ink polymer adhesion, or both when comparing real-time captured data to historical datasets.

Additionally, in some embodiments, the control processor may utilize the stored datasets to adjust and predict the initial extrusion parameters for a subsequent ink polymer prior to extrusion. In some embodiments, the method further comprises outputting graphical overlays of extrusion quality and calibration adjustments to an external computer device communicatively coupled to the control processor.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a graphical illustration depicting an elevated, isometric view of an auto-calibration system for direct ink writing (“DIW”) material flow for a printing mechanism, according to an embodiment of the present disclosure.

FIG. 2 is a graphical illustration depicting a front, isometric view of the auto-calibration system for DIW material flow for a printing mechanism, according to an embodiment of the present disclosure.

FIG. 3 is a graphical illustration depicting a side, isometric view of the auto-calibration system for DIW material flow for a printing mechanism, according to an embodiment of the present disclosure.

FIG. 4 is a graphical illustration depicting an imaging system and rapid sample exchange system of the auto-calibration system, according to an embodiment of the present disclosure.

FIG. 5 is a graphical illustration depicting a focused, isometric view of a nozzle of a printing mechanism, according to an embodiment of the present disclosure.

FIG. 6 is a graphical illustration depicting a perspective view of an extrudate deposited onto a platform from a nozzle of a printing mechanism, according to an embodiment of the present disclosure.

FIG. 7 is a flow chart depicting the steps of a method for monitoring ink flow for DIW printing, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

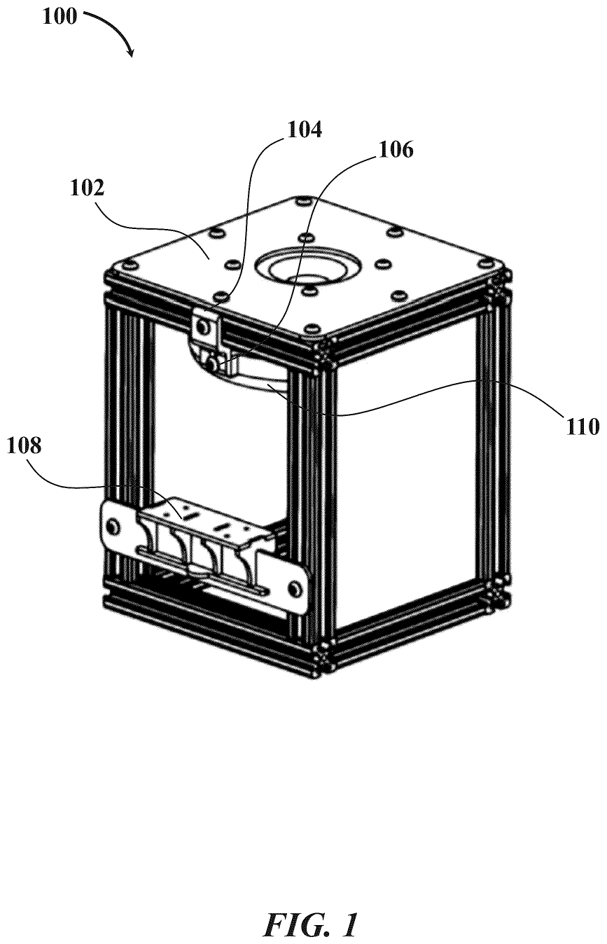

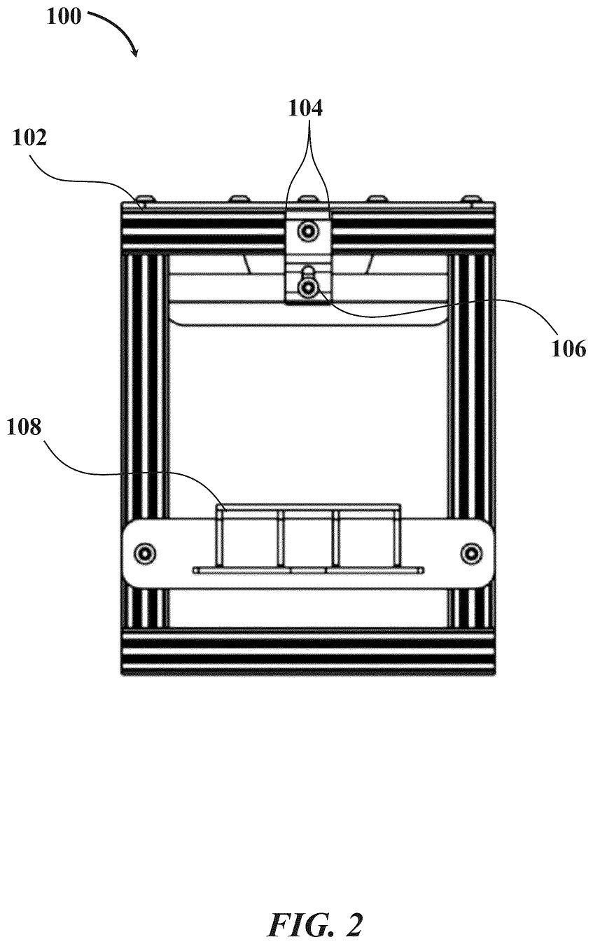

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compacts disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

As used herein, the term “communicatively coupled” refers to any coupling mechanism known in the art, such that at least one electrical signal may be transmitted between one device and one alternative device. Communicatively coupled may refer to Wi-Fi, Bluetooth, wired connections, wireless connection, and/or magnets. For case of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose, such as packaging and/or delivery of at least one prosthesis and/or prosthetic implant into a surgical pocket). As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about.” It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### System for Auto-Calibration of Direct-Ink Writing (“DIW”) Material Flow

The present disclosure pertains to an auto-calibration system (i.e., “system”) for direct ink writing (“DIW”) material flow that is configured for use with a printing mechanism to monitor, infer, and/or adjust extrusion behavior of an ink polymer during operation. In some embodiments, the system implements an imaging system comprising at least one camera and/or at least one illumination source. Moreover, in some embodiments the system includes a rapid sample exchange system having a syringe compartment in fluidic communication with a nozzle. Additionally, in some embodiments, the system comprises a data analysis and inference engine communicatively coupled to the imaging system and the rapid sample exchange system Furthermore, in some embodiments, the data analysis and inference engine is operable to process thermal and/or optical images of the extrudate captured in real time and/or to implement automatic adjustments to extrusion parameters of the printing mechanism based on calculated flow rate, deposition pattern, adhesion of the ink polymer, and/or a combination thereof.

As best depicted in FIG. 1, in some embodiments, system 100 can be incorporated into a printing mechanism 102. In this manner, printing mechanism 102 may include a mounted movable track 126, a nozzle 114, and/or a platform 108. Accordingly, system 100 may be incorporated into any printing mechanism 102 known in the art capable of DIW material printing for photoelectric polymers.

In some embodiments, system 100 includes an imaging system 104 disposed about printing mechanism 102 at one or more elevations relative to nozzle 114 such that both the extrudate ink polymer 118 and/or a deposition region on platform 108 are within a field of view of at least one camera 106 of imaging system 104.

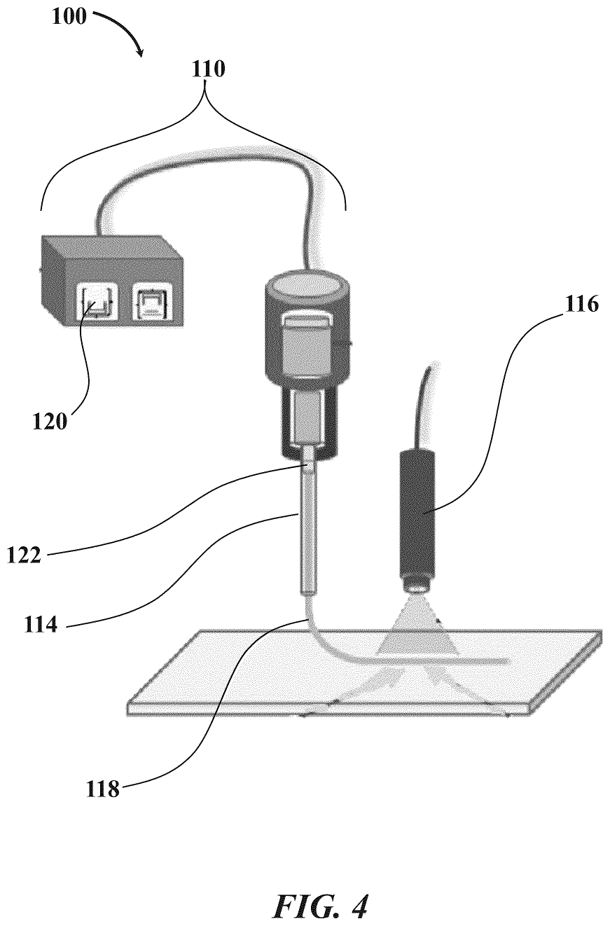

As shown in FIG. 2, in conjunction with FIG. 4, in some embodiments, imaging system 104 includes an illumination source 116 which can be positioned proximate to nozzle 114 and/or oriented toward the deposition region of platform 108 to facilitate image capture of extrudate ink polymer 118 geometry and/or surface condition. In some embodiments, illumination source 116 includes multiple spectral outputs to adjust contrast for inks having different transparency and/or color.

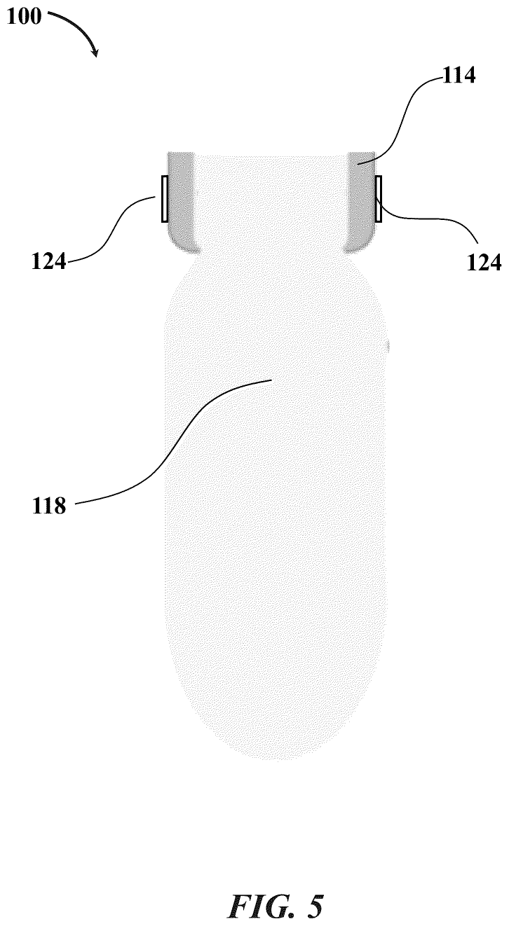

As best depicted in FIG. 4, in some embodiments, system 100 includes a rapid sample exchange system 110 comprising a syringe compartment 120 in fluidic communication with nozzle 114 configured to hold and/or transition between one or more ink polymers 118 during operation. Additionally, as shown in FIGS. 4-5, in some embodiments, syringe compartment 120 can be temperature-controlled via heating and cooling element 124 and/or monitored by a temperature sensor 122 to maintain a predetermined viscosity suitable for consistent flow through nozzle 114. In some embodiments, syringe bodies can be swapped without disassembling nozzle 114 in real-time during operation of printing mechanism 102.

As shown in FIGS. 1-3, in some embodiments, printing mechanism 102 may deliver ink polymer 118 through nozzle 114 toward platform 108 while imaging system 104 monitors the extrudate during deposition. As shown in FIG. 4, illumination source 116 may project a light onto the extrudate path while at least one camera 106 capture images. Accordingly, in some embodiments, the captured images can be electronically communicated to a data analysis and inference engine 112 for processing. In some other embodiments, platform 108 may be a replaceable planar substrate selected according to test or print setup.

As best depicted in FIG. 5, in some embodiments, nozzle 114 can include heating and cooling element 124 disposed adjacent to an outlet to regulate temperature of ink polymer 118 immediately before deposition. In this manner, control signals from a control processor operably coupled to data analysis and inference engine 112 may adjust heating and cooling element 124 based on real-time image analysis to maintain a desired rheological state during flow through nozzle 114.

In some embodiments, nozzle 114 is provided in multiple internal diameters and/or geometries to accommodate different ink formulations. Accordingly, system 100 may store a calibration profile for a given nozzle which may map extrusion pressure and/or print speed to observed flow rate and/or deposition width from imaging system 104. Moreover. data analysis and inference engine 112 can retrieve the profile to initialize parameters when a unique nozzle has been installed onto printing mechanism 102.

As shown in FIGS. 1-4, in some embodiments, imaging system 104 includes a plurality of cameras and/or at least one camera 106 positioned at different elevations and/or angular positions relative to nozzle 114 allowing multi-view reconstruction of extrudate geometry. In some other embodiments, a single camera 106 is utilized while nozzle 114 and/or platform 108 may be repositioned along track 126 to obtain multiple viewpoints. Moreover, in some other embodiments, imaging system 104 can record images and information in optical and/or thermal modes to monitor temperature distribution along the extrudate.

In some embodiments, temperature sensor 122 may be mounted on rapid sample exchange system 110 and/or proximate to nozzle 114 to measure temperature associated with ink polymer 118 during extrusion. In this manner, measurements from temperature sensor 122 may be correlated by data analysis and inference engine 112 with observed flow rate and/or deposition spread such that data analysis and inference engine 112 may compute adjustments to nozzle temperature, extrusion pressure, print speed, and/or in a combination thereof.

Moreover, in some embodiments, data analysis, and inference engine 112 may comprise a data storage module for calibration profiles and historical extrusion datasets for multiple ink polymers. Accordingly, data analysis and inference engine 112 may execute one or more algorithms which may segment the extrudate ink polymer 118 into images, estimate instantaneous flow rate from motion and/or cross-sectional measurements, compare observed deposition footprints with expected footprints for the current platform 108 and nozzle 114, and/or a combination thereof which enables closed-loop calibration.

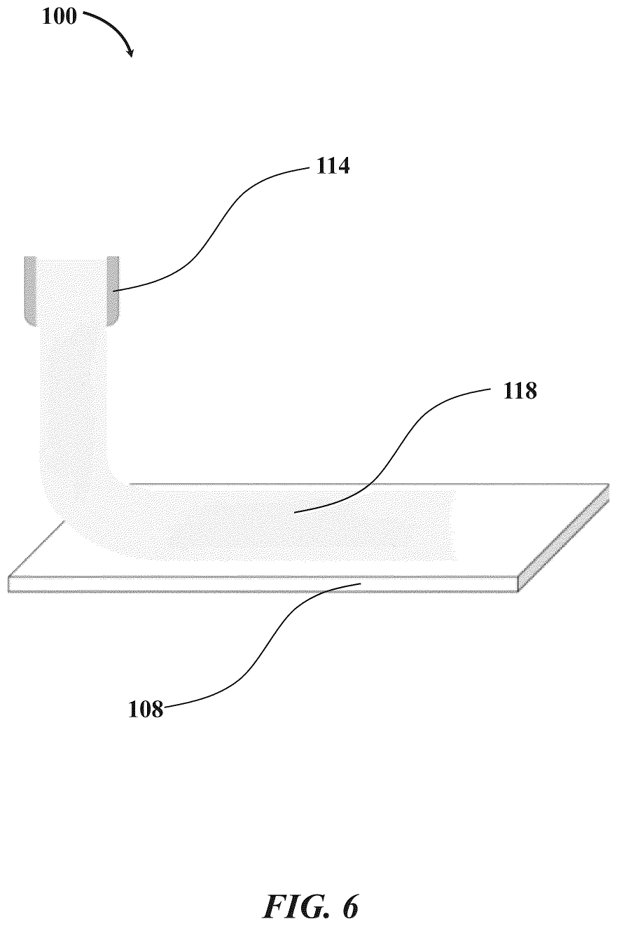

As shown in FIG. 6, ink polymer 118 is deposited from nozzle 114 onto platform 108 along a specified path. Moreover, in some embodiments, imaging system 104 can be configured to observe the extrudate immediately downstream of nozzle 114. Additionally, data analysis and inference engine 112 can be configured to determine whether the observed path, density, temperature, viscosity, and/or a combination thereof of ink polymer 118 are within acceptable tolerances range defined by an active calibration profile for each specific ink polymer 118.

In this manner, when deviations are detected, data analysis and inference engine 112 may signal adjustments to extrusion pressure, nozzle temperature, print speed, and/or a combination thereof. In some other embodiments, the diameter and/or length of nozzle 114 may be adjusted by data analysis and inference engine 112 in real-time such that the diameter of the nozzle may expand or lessen depending on the state of ink polymer 118 being extruded.

Moreover, in some embodiments, system 100 further comprises an environmental enclosure surrounding platform 108 and/or at least a portion of printing mechanism 102 to regulate ambient temperature, humidity, airflow, and/or a combination thereof. The enclosure may include an access panel for substrate exchange and maintenance. In some embodiments, a safety interlock may be disposed about a surface of printing mechanism 102 such that the safety interlock can monitor temperature sensor 122, heating/cooling element 124, enclosure access states, and/or a combination thereof. In this manner, the safety interlock may disable extrusion and/or heating when the desired predetermined conditions are not met.

In some other embodiments, system 100 includes an auxiliary metrology module configured to project structured light and/or utilize lasers to measure extrudate height above platform 108 at one or more positions downstream of nozzle 114. In this manner, the measurements from the auxiliary module may be supplied to data analysis and inference engine 112 to confirm deposition uniformity and/or to refine calibration profiles.

Moreover, in some embodiments, nozzle 114 includes an embedded pressure transducer situated near the outlet such that the embedded pressure transducer may measure local pressure fluctuations during the extrusion process. Accordingly, data analysis and inference engine 112 may correlate pressure signals with image-derived flow characteristics to identify the onset of instabilities including but not limited to strand undulation and/or post-exit arcing of ink polymer 118 and adjust one or more parameters of printing mechanism 102.

In some other embodiments, rapid sample exchange system 110 may support the translation and/or indexing of syringe compartment 120 such that syringe compartment 120 may align selected syringes with nozzle 114. In some other embodiments, one or more purge routines may be initiated by data analysis and inference engine 112 to clear any residual ink polymer 118 during transitions between formulations. In some embodiments, syringe compartment 120 is integrated with a microfluidic routing manifold configured to blend source syringes at controlled ratios and to incorporate static mixing and/or purge valving.

Additionally, in some embodiments, system 100 can include a vibration-isolating mount disposed under a bottom surface of platform 108. In this manner, the vibration-isolating mount may be configured to reduce motion during high-magnification imaging conducted by imaging system 104. In some embodiments, one or more cameras 106 are time-synchronized to permit multi-view measurement of extrudate ink polymer 118 geometry and motion. In this manner, at least one camera of the one or more cameras 106 may be aligned with the axis of nozzle 114 and may capture the outlet region at a high magnification.

In some other embodiments, system 100 includes a user interface that displays images from imaging system 104 with graphical overlays generated by data analysis and inference engine 112, including but not limited to flow vectors, estimated cross-section width, adhesion indicators, time-based plots of flow rate, and/or a combination thereof. In this manner, the user interface may allow selection of calibration profiles for a given ink polymer 118 and/or export of process logs to an external computing device for further research and/or analysis.

Furthermore, in some embodiments, one or more stored calibration profiles can include parameter ranges for extrusion pressure, nozzle temperature, print speed, and/or platform temperatures associated with target extrudate ink polymer 118 widths and/or deposition patterns for various nozzle 114 diameters. Accordingly, the one or more calibration profiles may be updated over time as data analysis and inference engine 112 records new outcomes under changing environmental and/or material conditions thereby enabling predictive adjustments when measured behavior indicates drift.

### Method of Training an Auto-Calibration System for DIW Material Flow

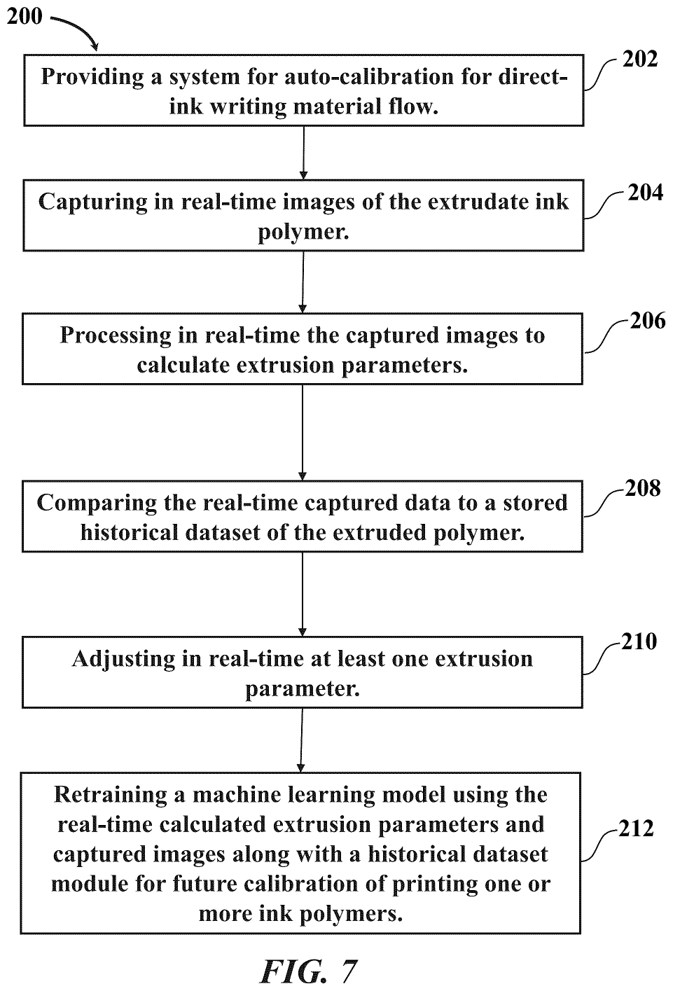

Referring now to FIG. 7, in conjunction with FIGS. 1-6, a method 200 is depicted for training an auto-calibration system 100 for direct-ink writing (“DIW”) material flow. The steps delineated are merely exemplary of a preferred order for training an auto-calibration system 100 for DIW material flow. The steps may be carried out in another order, with or without additional steps included therein. Additionally, the steps may be carried out with alternative embodiments of auto-calibration system 100.

As shown in FIG. 7, in some embodiments, method 200 begins with step 202, providing a system 100 for auto-calibration of DIW material flow. In some embodiments, system 100 comprises imaging system 104 including at least one camera 106 and/or at least one illumination source 116. Additionally, in some embodiments, system 100 includes a rapid sample exchange system 110 having syringe compartment 120 in fluidic communication with nozzle 114 and/or platform 108 to receive an extrudate of ink polymer 118. Moreover, system 100 can include data analysis and inference engine 112 communicatively coupled to the imaging system 104 and/or the rapid sample exchange system 110.

The next step, step 204, may comprise capturing in real time, via imaging system 104, images of the extrudate of ink polymer 118. In some embodiments, the captured images include thermal images, optical images, or both, of the extrudate ink polymer 118 as it is deposited onto platform 108. As shown in FIG. 4, in some embodiments, camera 106 and/or illumination source 116 may be positioned to ensure visibility of extrudate geometry and adhesion patterns.

Furthermore, in some embodiments, method 200 proceeds with step 206 of processing, in real time, the captured images via data analysis and inference engine 112. In this manner, the processing step calculates extrusion parameters including flow rate, deposition pattern, and/or adhesion of ink polymer 118. In some embodiments, data analysis and inference engine 112 executes one or more algorithms to segment the extrudate ink polymer 118 within the captured image sequences, measure displacement across frames, and/or determine instantaneous deposition rate.

As shown in FIG. 7, in conjunction with FIG. 4, in some embodiments, step 206 further comprises identifying deviations in flow uniformity, adhesion performance, or both, by correlating optical imaging with temperature sensor 122 data. Accordingly, in some embodiments, inference engine 112 can identify an adhesion failure event when ink polymer 118 does not adhere to platform 108 and/or signal corrective adjustment to the control processor.

In some embodiments, the control processor utilizes stored datasets to adjust and/or predict the initial extrusion parameters for a subsequent ink polymer prior to extrusion. In this manner, system 100 anticipates viscosity and/or adhesion properties associated with ink polymer 118 before deposition begins thereby reducing the likelihood of calibration errors.

Referring again to FIG. 7, in some embodiments, method 200 includes step 208 of comparing the real-time captured data with a stored historical dataset of extruded ink polymers. Accordingly, the historical dataset may include calibration profiles of one or more various nozzles 114, platform surfaces 108, and/or ink polymers 118. In this manner, data analysis and inference engine 112 can identify deviations in flow uniformity, polymer adhesion, or both, relative to expected deposition performance of the ink polymer 118.

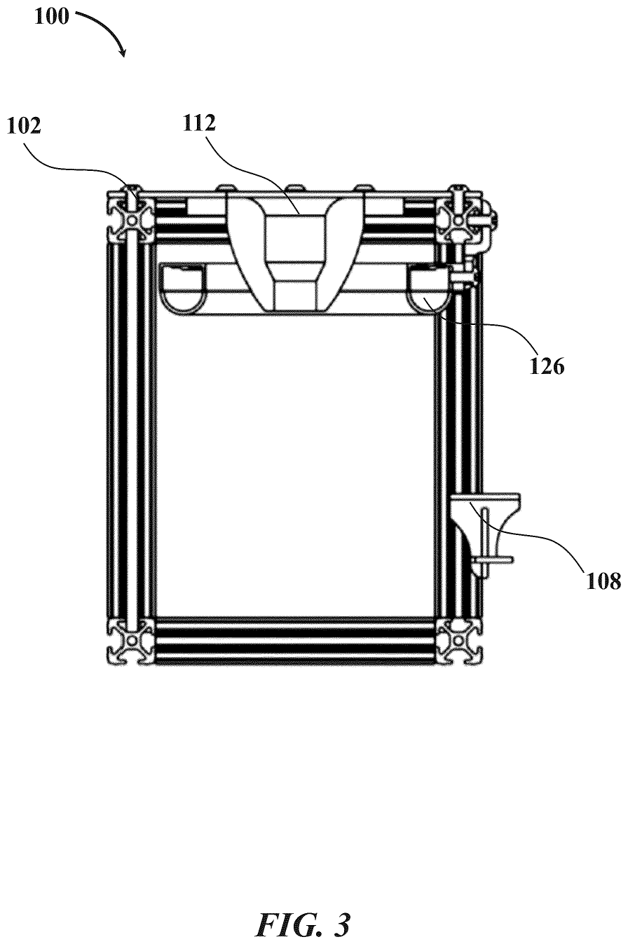

As further shown in FIG. 7, method 200 may comprise step 210 of adjusting, in real time, at least one extrusion parameter via a control processor operably coupled to system 100 and/or printing mechanism 102. As shown in FIGS. 3-5, the extrusion parameters may include extrusion pressure, nozzle temperature controlled by heating and cooling element 124 and/or print speed along track 126.

In some embodiments, method 200 may also include the step 212 of retraining, via data analysis and inference engine 112, a machine learning model using the real-time calculated extrusion parameters, the captured images, stored historical dataset, and/or a combination thereof. Accordingly, step 212 may generate improved calibration models for future printing operations involving one or more ink polymers 118. Accordingly, data analysis and inference engine 112 may increase the predictive accuracy with each iteration.

Moreover, in some embodiments, method 200 further comprises generating a dataset from the captured images and calculated extrusion parameters. Accordingly, the dataset may be applied to train a machine learning algorithm for predicting extrusion behavior of subsequent ink polymers. Additionally, in some embodiments, the dataset may include flow rates, adhesion scores, and/or deposition widths associated with specific nozzle diameters and/or syringe compartment temperatures.

Additionally, in some embodiments, method 200 may be extended to include machine-to-machine communication between multiple auto-calibration systems 100 operating in parallel. In this manner, datasets generated from each system may be shared to accelerate retraining and calibration of novel ink polymer formulations.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

### Glossary of Claim Terms

Adhesion means the measurable tendency of the extruded ink polymer to remain affixed to the platform or substrate after deposition from the nozzle. In the context of the present claims, adhesion is evaluated by the data analysis and inference engine using image-based measurements of the footprint of the deposited extrudate. Characteristics that are assessed include the degree of spreading, the continuity of contact along the deposition line, and whether detachment or lift-off events occur during extrusion. Adhesion is an important characteristic monitored by the imaging system since loss of adhesion can result in incomplete or misaligned deposition patterns. The rapid sample exchange system and the heating and cooling elements may influence adhesion by regulating viscosity and temperature of the ink polymer during extrusion. Additionally, calibration profiles stored in the data storage module may include adhesion ranges associated with specific nozzle geometries, extrusion pressures, and platform surface conditions. The control processor may adjust parameters such as nozzle temperature, extrusion pressure, or platform temperature when adhesion deviates from stored profiles. Adhesion may be reported as binary success or failure events, or as quantitative indices such as contact width or adhesion percentage relative to intended deposition length. In some embodiments, adhesion measurements are compared against historical datasets to improve predictive calibration for subsequent ink polymers. Thus, adhesion within the meaning of the claims encompasses the interaction of material flow, substrate condition, and process control leading to measurable attachment of extrudate during DIW operation.

Calibration Profile means a stored set of parameters, ranges, and correlations that define the relationship between extrusion conditions and observable deposition characteristics for a given ink polymer and nozzle configuration. In the context of the claimed system, a calibration profile may include values or ranges for extrusion pressure, nozzle temperature, platform temperature, print speed, and observed extrudate dimensions such as width and height. Calibration profiles are generated from historical data captured by the imaging system and stored within the data storage module of the data analysis and inference engine. During operation, a calibration profile is retrieved to initialize parameters when a known combination of ink polymer formulation and nozzle geometry is selected. The inference engine compares real-time imaging data with the active calibration profile to determine whether deposition is within acceptable tolerances. If deviations are detected, the control processor may adjust extrusion parameters in real time to restore alignment with the calibration profile. Calibration profiles may be updated iteratively as new data is collected during operation, thereby refining predictive accuracy for subsequent runs. In some embodiments, profiles may incorporate multiple environmental conditions including humidity and airflow, allowing compensation under varying ambient conditions. In some other embodiments, calibration profiles may store data associated with failure events such as adhesion loss, enabling preemptive parameter adjustments. Therefore, calibration profile within the meaning of the claims refers to a structured dataset that encodes empirical or inferred relationships between input extrusion parameters and output deposition behavior for guiding automated calibration.

Control Processor means an electronic processing unit operably coupled to the printing mechanism, imaging system, rapid sample exchange system, and the data analysis and inference engine. Within the context of the claims, the control processor receives image-derived flow characteristics and communicates control signals to adjust extrusion parameters such as extrusion pressure, nozzle temperature, and print speed. The control processor may also execute predictive algorithms, using calibration profiles and stored datasets, to preemptively adjust parameters when a deviation is inferred before it occurs in real time. In some embodiments, the control processor receives alerts from the inference engine when adhesion failures or flow deviations are detected and initiates corrective adjustments to restore acceptable operation. The control processor may further coordinate transitions between syringe compartments in the rapid sample exchange system, as well as regulate heating and cooling elements in proximity to the nozzle or syringe compartment. In some embodiments, the control processor is integrated into the inference engine hardware, while in other embodiments it may be a separate component communicatively linked to the system. The control processor may also provide communication to external devices, such as user interfaces or supervisory systems, to report system status, calibration overlays, and data logs. Accordingly, control processor within the meaning of the claims refers to a hardware or software-driven computing unit configured to manage and dynamically adjust the DIW printing mechanism and associated subsystems based on real-time analysis of imaging and historical data.

Data Analysis and Inference Engine means the computational subsystem configured to receive images from the imaging system, analyze extrudate characteristics, compare measured values to calibration profiles, and instruct the control processor to adjust parameters during DIW operation. As recited in the claims, the inference engine processes captured images to calculate material flow characteristics such as flow rate, deposition pattern, and adhesion of ink polymer. The inference engine further stores calibration profiles and historical datasets for different ink polymers and nozzle geometries, allowing the system to initialize or update extrusion parameters based on past data. In some embodiments, the inference engine executes machine learning algorithms that retrain continuously during operation, incorporating real-time data into predictive models for subsequent ink polymer extrusions. In other embodiments, the inference engine may generate graphical overlays representing deposition quality, which may be transmitted to an external device. The inference engine may also classify events such as adhesion failures and transmit these classifications to the control processor. In some embodiments, the inference engine further supports federated or distributed learning by integrating calibration data across multiple systems. Thus, the data analysis and inference engine within the meaning of the claims refers to a processing and storage component configured to analyze optical and/or thermal images, compute deposition characteristics, manage calibration profiles, retrain models, and output parameter adjustments to achieve automated real-time calibration of DIW extrusion.

Extrusion Parameters means the operational settings applied to the printing mechanism to regulate the discharge of ink polymer through the nozzle. In the context of the claimed invention, extrusion parameters include extrusion pressure, nozzle temperature, print speed, and in some embodiments, platform temperature. These parameters directly influence flow rate, deposition pattern, and adhesion characteristics of the ink polymer. In some embodiments, extrusion parameters are initially selected based on calibration profiles stored in the inference engine. During printing, the imaging system captures images of the extrudate, and the inference engine compares observed characteristics to expected deposition ranges. When deviations are detected, the inference engine directs the control processor to adjust one or more extrusion parameters in real time. For example, nozzle temperature may be increased to decrease viscosity of a highly resistant ink polymer or print speed may be reduced to improve adhesion along a path. Extrusion parameters may also be adjusted preemptively based on predictive algorithms that use historical data to forecast outcomes. In some embodiments, extrusion parameters may be logged along with resulting deposition characteristics to expand calibration datasets for future use. Accordingly, extrusion parameters within the meaning of the claims encompasses the controllable operational variables that determine how ink polymer is extruded and deposited, and that are dynamically adjusted by the control processor in response to inference engine analysis.

What is claimed is:

1. A system for auto-calibration of direct-ink writing (“DIW”) material flow, comprising:
an imaging system comprising at least one camera and at least one illumination source;
a rapid sample exchange system including a syringe compartment in fluidic communication with a nozzle of a printing apparatus, the syringe compartment being configured to transition between one or more ink polymers within the printing mechanism during operation;
a data analysis and inference engine communicatively coupled to the imaging system and the rapid sample exchange system;
wherein the imaging system is configured to capture one or more thermal images, optical images, or both of the extruded ink polymer, in real time;
wherein the data analysis and inference engine is configured to process the one or more captured images to determine material flow characteristics including flow rate, ink polymer deposition pattern, and ink polymer adhesion; and
wherein the data analysis and inference engine is configured to automatically adjust extrusion parameters of the ink polymer from the printing mechanism, in real-time, based on the calculated flow rate, the ink polymer deposition pattern, and the ink polymer adhesion.

2. The system of claim 1, wherein the imaging system comprises a plurality of cameras positioned about the printing mechanism at various elevations relative to the nozzle of the printing mechanism.

3. The system of claim 1, wherein the imaging system further comprises an adaptive illumination source configured to optimize image quality for different ink polymers having various transparency, color, or both.

4. The system of claim 1, wherein the rapid sample exchange system further comprises a temperature-controlled compartment configured to maintain a predetermined viscosity of the ink polymer.

5. The system of claim 1, further comprising a control processor operably coupled to the printing mechanism, imaging system, rapid sample exchange system, and the data analysis and inference engine.

6. The system of claim 1, wherein the data analysis and inference engine further comprises a data storage module configured to store calibration profiles, historical extrusion data of the ink polymers, or both.

7. The system of claim 6, wherein the control processor is configured to implement predictive adjustments to the extrusion pressure, nozzle temperature, or print speed.

8. The system of claim 7, wherein the data analysis and inference engine is configured to identify adhesion failure events from the captured images from the imaging system and electrically communicate the failure events to the control processor.

9. The system of claim 8, wherein the control processor is configured to adjust the extrusion pressure, nozzle temperature, or print speed of the ink polymer in response to an adhesion failure notification received from the data analysis and inference engine.

10. The system of claim 9, wherein the system further comprises a nozzle heating and cooling mechanically coupled to the nozzle and operably coupled to the control processor.

11. A system for auto-calibration of direct-ink writing (“DIW”) material flow, comprising:
an imaging system comprising at least one camera and at least one illumination source;
a rapid sample exchange system including a syringe compartment in fluidic communication with a nozzle of a printing apparatus, the syringe compartment being configured to transition between one or more ink polymers within the printing mechanism during operation;
a data analysis and inference engine communicatively coupled to the imaging system and the rapid sample exchange system;
a data storage module configured to store calibration profiles of the ink polymers and maintain historical extrusion data of the ink polymers;
wherein the imaging system is configured to capture one or more thermal images, optical images, or both of the extruded ink polymer, in real time;
wherein the data analysis and inference engine is configured to process the one or more captured images to determine material flow characteristics including flow rate, ink polymer deposition pattern, and ink polymer adhesion; and
wherein the data analysis and inference engine is configured to automatically adjust extrusion parameters of the ink polymer from the printing mechanism, in real-time, based on the calculated flow rate, the ink polymer deposition pattern, and the ink polymer adhesion.

12. The system of claim 11, wherein the imaging system comprises a plurality of cameras positioned about the printing mechanism at various elevations relative to the nozzle of the printing mechanism.

13. The system of claim 11, wherein the imaging system further comprises an adaptive illumination source configured to optimize image quality for different ink polymers having various transparency, color, or both.

14. The system of claim 11, wherein the rapid sample exchange system further comprises a temperature-controlled compartment configured to maintain a predetermined viscosity of the ink polymer.

15. The system of claim 11, further comprising a control processor operably coupled to the printing mechanism, imaging system, rapid sample exchange system, and the data analysis and inference engine.

16. A method of training an auto-calibration system for direct-ink writing (“DIW”) material flow, comprising:
providing a system for auto-calibration for DIW material flow, the system comprising:
an imaging system comprising at least one camera and at least one illumination source;
a rapid sample exchange system including a syringe compartment in fluidic communication with a nozzle of a printing apparatus, the syringe compartment being configured to transition between one or more ink polymers within the printing mechanism during operation;
a data analysis and inference engine communicatively coupled to the imaging system and the rapid sample exchange system;
wherein the imaging system is configured to capture one or more thermal images, optical images, or both of the extruded ink polymer, in real time;
wherein the data analysis and inference engine is configured to process the one or more captured images to determine material flow characteristics including flow rate, ink polymer deposition pattern, and ink polymer adhesion; and
wherein the data analysis and inference engine is configured to automatically adjust extrusion parameters of the ink polymer from the printing mechanism, in real-time, based on the calculated flow rate, the ink polymer deposition pattern, and the ink polymer adhesion;
capturing in real-time, via the imaging system, images of the extrudate ink polymer;
processing in real-time, via the data analysis and inference engine, the captured images to calculate extrusion parameters including flow rate, deposition patterns, and ink polymer adhesion;
comparing, via the data analysis and inference engine, the real-time captured data to a stored historical dataset of the extruded polymer;
adjusting in real-time, via a control processor operably coupled to the system for auto-calibration of DIW material flow and the printing mechanism, at least one extrusion parameter; and
retraining, via the data analysis and inference engine, a machine learning model using the real-time calculated extrusion parameters and captured images along with a historical dataset module for future calibration of printing one or more ink polymers.

17. The method of claim 16, further comprising generating a dataset from the captured images and extrusion parameters for training a machine learning algorithm to predict extrusion behavior of subsequent ink polymers.

18. The method of claim 16, wherein the step of comparing real-time captured data to the stored historical dataset further comprises identifying deviations in flow uniformity, ink polymer adhesion, or both.

19. The method of claim 16, wherein the control processor utilizes the stored datasets to adjust and predict the initial extrusion parameters for a subsequent ink polymer prior to extrusion.

20. The method of claim 16, further comprising outputting graphical overlays of the extrusion quality of the ink polymers to an external computer device communicatively coupled to the control processor.
